(19) United States
(12) Patent Application Publication
(10) Pub. No.: US 2014/0372999 A1
(43) Pub. Date: Dec. 18, 2014

(54) COMPUTER SYSTEM FOR UPDATING PROGRAMS AND DATA IN DIFFERENT MEMORY AREAS WITH OR WITHOUT WRITE AUTHORIZATIONS

(71) Applicant: Bernd Becker, Blaustein (DE)

(72) Inventor: Bernd Becker, Blaustein (DE)

(21) Appl. No.: 14/369,985

(22) PCT Filed: Dec. 19, 2012
(86) PCT No.: PCT/EP2012/076219

§ 371 Date: Jun. 30, 2014

(30) Foreign Application Priority Data
Jan. 5, 2012 (DE) 10 2012 200 155.7

(51) Int. Cl. G06F 9/445

(52) U.S. Cl. CPC G06F 8/67
USPC 717/169

(57) ABSTRACT

A computer system includes: a processor configured to execute a master operating system core and a first and a second operating system core under the control of the master operating system core; a first mass memory configured to store a software management database; and a second mass memory configured to store system files and program files for the second operating system core. The first operating system core is configured to carry out software updates for the second operating system core using the software management database.

### CROSS-REFERENCE TO RELATED APPLICATIONS

This is a U.S. national stage of application No. PCT/EP2012/076219, filed on 19 Dec. 2012, which claims priority to the German Application No. 10 2012 200 155.7, filed 5 Jan. 2012, the content of both incorporated herein by reference.

### BACKGROUND OF THE INVENTION

1. Field of the Invention

The invention relates to a computer system that can be used in a motor vehicle, for example, and to a method for operating a computer system.

2. Related Art

In conventional computer systems, installed software, including operating system files, is managed on the basis of information stored in a database, for example. In this case, such software management can control which programs can be installed on the computer system or else which program versions are permissible for the installed programs. In particular, such software management is able to prevent unauthorized software from being installed on the computer system.

This principle is based on the fact that the software management is trusted and possible installation or updating programs come from trusted sources, which in turn can be checked by the software management.

However, if there is undesirable access to the software management and/or the software management database by malware on the computer system, for example a virus, a program that uses a security gap of the computer system or the like, the trusted position of the software management can be compromised. As a result, it is subsequently possible, for example, to also install software that is actually not approved for the computer system and therefore to generate further security gaps in the computer system, for example.

In conventional computer systems, an attempt is accordingly made, for example, to discover and eliminate malware, which might attack the software management, before the malware is executed.

### SUMMARY OF THE INVENTION

An object of the present invention is to specify an improved security concept for the software management of a computer system.

An aspect of the invention is based on separating the software management of a system from the system to be managed and carrying it out in an independent, secure system. For example, two independent operating system cores or operating systems based thereon are executed on the computer system for this purpose, in which case a first operating system core carries out the software management for the second operating system core. In order to protect the security of the first operating system core and a software management database, independent mass memories are also provided, in which case the software management database is stored, inter alia, in a first mass memory and system files and program files for the second operating system core are stored in the second mass memory. As a result, even if the second operating system core is compromised, trustworthiness of the software management or the software management database can be maintained, with the result that the installation of undesirable software on the second operating system core is prevented.

According to one embodiment, a computer system has a processor, a first mass memory and a second mass memory. The computer system is configured to execute on the processor a master operating system core and a first and a second operating system core under the control of the master operating system core. The first mass memory is configured to store a software management database. The second mass memory is configured to store system files and program files for the second operating system core. The first operating system core is configured to carry out software updates for the second operating system core using the software management database. In different embodiments, the first operating system core also carries out software updates for the first operating system core. System files and program files for the first operating system core are preferably stored in the first mass memory.

Accordingly, the master operating system core, which is in the form of a microkernel or separation kernel, for example, is first of all executed on the computer system or the processor. The master operating system core accordingly makes it possible to execute or control the first and second operating system cores independently of one another, with the result that the two operating system cores being controlled do not have access to processes, memories or the like belonging to the respective other operating system core.

The first operating system core is preferably set up for a secure operating system on which only a small number of programs run, in particular, which programs substantially do not require any interaction with a user, apart from for management purposes. The second operating system core is set up to execute fundamentally any desired programs, for example multimedia applications such as web browsers, software for playing back music, image viewing software, document viewers or the like. In particular, programs that potentially threaten security can therefore also be executed under the second operating system core.

Access to the first and second mass memories is preferably regulated by the first and second operating system cores. In particular, read accesses and write accesses to the first and second mass memories are controlled by the master operating system core, for example.

In one embodiment, the first operating system core respectively has read access and write access to the first and second mass memories, while the second operating system core does not have read access and write access to the first mass memory and has read access but no write access to the second mass memory. Accordingly, only the first operating system core is able to have write access to the first and, in particular, the second mass memory in order to store or change system files and program files for the operating system cores. Even if the second operating system core is compromised, the installed system and program files cannot be changed owing to the lack of write access to the second mass memory. Furthermore, the lack of read access and write access to the first mass memory prevents the second operating system core from being able to read the software management database and thereby obtaining information relating to installed software or the authorization to install software, for example.

In different embodiments, system files and program files for the second operating system core are stored exclusively in the second mass memory. This results in programs and system files for the second operating system core being controlled exclusively by the first operating system core.

The first operating system core is preferably set up to operate with security guidelines and/or to execute a virus scanner.

In further embodiments, the first mass memory is also configured to store security certificates, the first operating system core being configured to authenticate files to be installed using at least one of the stored security certificates when carrying out the software updates. The security certificates are based, for example, on cryptographic encryption or signing of files to be installed. This makes it possible to install only files that have been authenticated with the key or certificate that is secret per se. If the second operating system core does not have read access to the first mass memory, reading of the security certificates by malware on the second operating system core can also be prevented, with the result that undesirable compromising of the security certificates can be prevented.

In further embodiments, the computer system also has a third mass memory, in particular for storing user data, the second operating system core having read access and write access to the third mass memory. This makes it possible to store data that arrive at the second operating system core via a network connection or in another manner, for example. In this case, the master operating system core is preferably configured to prevent or at least regulate execution of programs stored in the third mass memory. In this case, programs are considered to be any forms of executable files including script files and program libraries. For example, particular script files such as Javascript, which is required for HTML5, may be approved for execution. Owing to the limited write rights, permanent damage of the overall system is also prevented in the case of malicious script files.

In one embodiment of the computer system, the first and second mass memories are arranged on a common mass storage medium, in particular a non-volatile mass storage medium. The mass storage medium is, for example, a so-called flash memory such as a multimedia card (MMC) or a secure digital memory card (SD card) or the like. For example, the non-volatile mass storage medium is a NAND memory, a NOR memory or a managed NAND memory which can each be permanently soldered to the printed circuit board of the computer system. In other embodiments, the mass storage medium may also be a hard disk or a solid state drive (SSD).

The computer system is configured, in particular, for operation in a motor vehicle. For example, the computer system is in the form of an embedded system. However, the computer system may also be used in other environments.

In one embodiment of a method for operating a computer system, a software management database is stored in a first mass memory. System files and program files for a first operating system core are stored in the first mass memory and/or a second mass memory. Furthermore, system files and program files for a second operating system core are stored in the second mass memory. In the computer system, a master operating system core is executed and the first and second operating system cores are executed, each under the control of the master operating system core. Software updates for the second operating system core are carried out by the first operating system core using the software management database.

Further embodiments and refinements of the method directly emerge from the previously described embodiments of the computer system.

In the previously described embodiments, software inside an operating system is updated outside this operating system on the basis of the second operating system core. In a Linux-based system, for example, this can be achieved by virtue of the package manager, for example RPM, DPKG or APK, being separated from the operating system to be managed and being executed under the first operating system core. In addition, the operating system with the second operating system core cannot write to its own file system in order to change libraries, executable files and configuration files because this is prevented by using the master operating system core, which is in the form of a microkernel or separation kernel, for example. In contrast to complete hardware separation between the two operating system cores, the non-volatile mass memories are controlled by a single entity in the proposed computer system, in which case it is simultaneously possible to execute secure operating systems with the first operating system core, which nevertheless can update the content of the non-volatile mass memories.

### BRIEF DESCRIPTION OF THE DRAWING

The invention is explained in more detail below using an exemplary embodiment on the basis of the single FIG. 1, in which:

FIG. 1 shows an exemplary embodiment of a computer system.

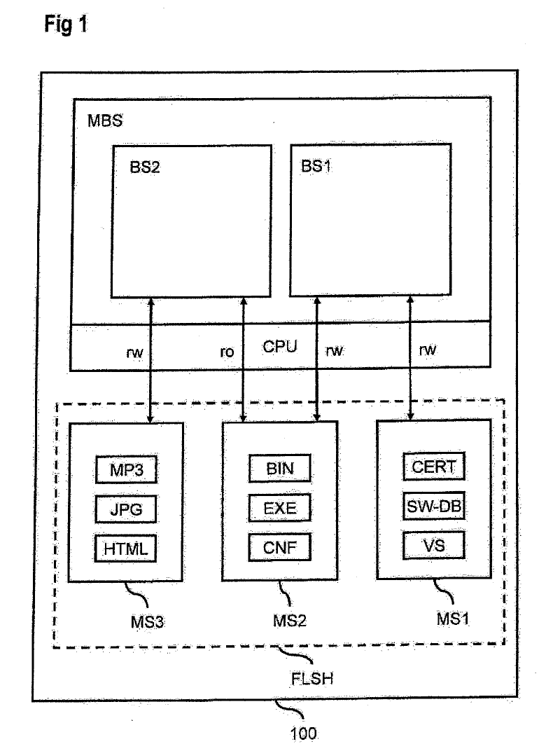

### DETAILED DESCRIPTION OF THE PRESENTLY PREFERRED EMBODIMENTS

A computer system 100 illustrated by way of example comprises a processor CPU and a mass storage medium FLSH, which is in the form of a flash memory or a hard disk or a solid state drive, for example. Three mass memories MS1, MS2, MS3, which are created as partitions on the mass storage medium FLSH, for example, are set up on the mass storage medium FLSH, for example. At least one master operating system core MBS, which comprises or controls two operating system cores BS1, BS2, which can be operated separately, runs on the processor CPU of the computer system 100.

The master operating system core is implemented, for example, as a microkernel which, in contrast to a conventional monolithic kernel, comprises only fundamental functions such as memory and process management and basic synchronization and communication functions.

However, the master operating system core is preferably in the form of a separation kernel that operates as a security kernel in order to simulate a distributed environment. In particular, the separation kernel is configured to control the first operating system core BS1 and the second operating system core BS2 separately from one another. In a modification of the embodiment illustrated, the master operating system core MBS can also control further operating system cores that run in parallel with the first and second operating system cores BS1, BS2 but are not illustrated here for reasons of clarity.

The left-hand operating system core BS2 is used to execute a conventional operating system, which makes it possible to use Internet applications such as a web browser, downloadable applications and multimedia functionality. The operating system core BS2 is preferably secure, in which case it is not necessary to provide increased reliability. Operating system files, applications, library files and configuration files are stored for the second operating system core BS2 in the second mass memory MS2. For this purpose, the second mass memory MS2 has, for example, storage space for system files BIN, executable files EXE and configuration files CNF. The master operating system core MBS ensures that the second operating system core BS2 has only read access but no write access to the second mass memory MS2, indicated by ro (read only). User data such as music files MP3, image files JPG or other Internet formats HTML are stored in the third mass memory MS3 to which the second operating system core BS2 has both read and write access. This is indicated by the designation rw (read write).

The right-hand operating system core BS1 is used to execute a secure operating system under which a software management program runs. Furthermore, a virus scanner and/or particular security guidelines may also be implemented under the first operating system core BS1. Access to the first operating system core is preferably provided only for maintenance purposes, with the result that no non-secure multimedia applications or the like can be executed, in particular. The first operating system core BS1 has write access and read access to the first and second mass memories MS1, MS2. A software management database SW-DB, security certificates CERT and a virus scanner VS are stored in the first mass memory MS1. Operating system files, applications, library files and configuration files for the first operating system core BS1 are either likewise stored in the second mass memory MS2 or preferably in the first mass memory MS1. The second operating system core BS2 has no access at all to the first mass memory MS1 and preferably also has no knowledge of the existence of this mass memory MS1. Access to the mass storage medium FLSH or the mass memories MS1, MS2, MS3 is controlled by the master operating system core MBS, with the result that malware that is executed under the second operating system core BS2 also has no access to the software management database and the security certificates. In addition, malware also cannot change any system files or applications in the second mass memory MS2. Further mass memories which store, for example, system files for the master operating system core MBS may preferably also be provided on the mass storage medium FLSH.

The first operating system core BS1 is accordingly used to update the software of the second operating system core BS2, which first operating system core updates the system files and applications in the second mass memory MS2 on the basis of the software management database. For this purpose, software packages to be installed are preferably authenticated with respect to the stored security certificates, with the result that only software packages from trusted sources that are aware of the security certificate can be installed. For example, the software management is based on a package manager. When using a Linux-based system, for example, such a package manager may be formed by the RPM (formerly red-hat) package manager (RPM), the Debian package manager (DPKG) or the Android package manager (APK).

The illustrated embodiment of the computer system makes it possible to prevent system files from being changed and therefore to prevent the deliberate opening of further security gaps starting from the second operating system core BS2 even when the second operating system core BS2 is compromised by malware. This is because the Internet capability and multimedia capability of the second operating system core fundamentally result in the risk of malware being able to be introduced in the region of the second operating system core BS2 as a result of undetected or newly occurring security gaps in the system, which malware, however, cannot result in the operating system being permanently changed under the second operating system core BS2 on account of the lack of write authorization. This means that malware cannot remain in the computer system when the system is switched off and on again.

Such malware, under the second operating system core BS2, is also prevented from reading the security certificates stored in the first mass memory MS1 in order to produce compromising installation packages from knowledge of the key that has been read.

The master operating system core MBS also preferably controls the situation in which execution of programs stored in the third mass memory MS3 is prevented or at least regulated. In this case, programs can be understood as meaning any executable files including program scripts and program libraries. Such programs may be loaded into the operating system of the second operating system core BS2 via an external storage medium or via an Internet connection, for example, and can be stored in the third mass memory MS3. For example, particular script files such as Javascript, which is required for HTML5, may be approved for execution. Owing to the limited write rights, permanent damage of the overall system is also prevented in the case of malicious script files.

The separation of the software updating from the operating system to be actually updated to another operating system core therefore effectively prevents updating with malicious programs by the operating system itself to be updated. Consequently, it is possible to make the operating system under the second operating system core BS2 more open to Internet applications with potential malicious code without threatening the security of the overall computer system.

In contrast to implementation of the operating system cores BS1, BS2 on different hardware platforms, the use of the master operating system core MBS, which jointly controls the two operating system cores BS1, BS2, enables unified security management. In addition, in the described embodiment of the computer system, access to the mass storage medium FLSH and to the mass memories MS1, MS2, MS3 is also under the sole control of the master operating system core MBS.

The computer system 100 is configured, in particular, for operation in a motor vehicle. For example, the computer system 100 is in the form of an embedded system. However, the computer system 100 may also be used in other environments.

For example, the non-volatile mass storage medium FLSH is a NAND memory, a NOR memory or a managed NAND memory, which may each be permanently soldered to the printed circuit board of the computer system 100.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-14. (canceled)

15. A computer system (100) comprising:
a processor (CPU) configured to execute a master operating system core (MBS) and a first and a second operating system core (BS1, BS2) under the control of the master operating system core (MBS);
a first mass memory (MS1) configured to store a software management database; and
a second mass memory (MS2) configured to store system files and program files for the second operating system core (BS2),
wherein the first operating system core (BS1) is configured to carry out software updates for the second operating system core (BS2) using the software management database.

16. The computer system (100) as claimed in claim 15, wherein the first operating system core (BS1) respectively has read access and write access to the first and second mass memories (MS1, MS2), and the second operating system core (BS2) does not have read access and write access to the first mass memory (MS1) and has read access, but no write access, to the second mass memory (MS2).

17. The computer system (100) as claimed in claim 16, wherein read accesses and write accesses to the first and second mass memories (MS1, MS2) are controlled by the master operating system core (MBS).

18. The computer system (100) as claimed in claim 15, wherein system files and program files for the second operating system core (BS2) are stored exclusively in the second mass memory (MS2).

19. The computer system (100) as claimed in claim 15, wherein the first operating system core (BS1) is configured to operate with security guidelines and/or to execute a virus scanner.

20. The computer system (100) as claimed in claim 15, wherein the second operating system core (BS2) is configured to execute at least one of the following:
a multimedia application;
a web browser;
software for playing back music;
image viewing software; and
a document viewer.

21. The computer system (100) as claimed in claim 15, wherein the first mass memory (MS1) is configured to store security certificates, the first operating system core (BS1) being configured to authenticate files to be installed using at least one of the stored security certificates when carrying out the software updates.

22. The computer system (100) as claimed in claim 15, further comprising a third mass memory (MS3) configured to store user data, the second operating system core (BS2) having read access and write access to the third mass memory (MS3).

23. The computer system (100) as claimed in claim 22, wherein the master operating system core (MBS) is configured to prevent or regulate execution of programs stored in the third mass memory (MS3).

24. The computer system (100) as claimed in claim 15, further comprising a common non-volatile mass storage medium (FLSH), wherein the first and second mass memories (MS1, MS2) are arranged on the common non-volatile mass storage medium (FLSH).

25. The computer system (100) as claimed in claim 15, wherein the master operating system core (MBS) comprises a microkernel or a separation kernel.

26. The computer system (100) as claimed in claim 15, the computer system (100) being configured for operation in a motor vehicle.

27. The computer system (100) as claimed in claim 15, the computer system (100) being in the form of an embedded system.

28. A method for operating a computer system, the method comprising:
storing a software management database in a first mass memory (MS1);
storing system files and program files for a first operating system core (BS1) in the first mass memory (MS1) and/or a second mass memory (MS2);
storing system files and program files for a second operating system core (BS2) in the second mass memory (MS2);
executing a master operating system core (MBS);
executing the first and second operating system cores (BS 1, BS2), each under the control of the master operating system core (MBS); and
carrying out software updates for the second operating system core (BS2) by the first operating system core (BS1) using the software management database.
